(19) United States
(12) Patent Application Publication
(10) Pub. No.: US 2020/0355516 A1
(43) Pub. Date: Nov. 12, 2020

(54) INFORMATION PROVIDING DEVICE AND INFORMATION PROVIDING PROGRAM

(71) Applicant: TOYOTA JIDOSHA KABUSHIKI KAISHA, Toyota-shi (JP)

(72) Inventor: Taiki NAKAMURA, Toyoake-shi (JP)

(73) Assignee: TOYOTA JIDOSHA KABUSHIKI KAISHA, Toyota-shi (JP)

(21) Appl. No.: 16/845,151

(22) Filed: Apr. 10, 2020

(30) Foreign Application Priority Data
May 10, 2019 (JP) 2019-090089

(51) Int. Cl. G01C 21/36; G01C 21/34; B60L 53/00

(52) U.S. Cl. CPC G01C 21/3697; B60L 53/00; G01C 21/3605; G01C 21/3469

(57) ABSTRACT

An information providing device including: a destination setting unit configured to set a destination of a motor-driven vehicle based on an input operation of a user of the motor-driven vehicle; a charging equipment retrieving unit configured to retrieve whether there is charging equipment by which the motor-driven vehicle is able to be charged at the destination; and a route providing unit configured to change a route on which the motor-driven vehicle moves to the destination depending on whether there is charging equipment at the destination and to provide the route to the user of the motor-driven vehicle.

### INCORPORATION BY REFERENCE

The disclosure of Japanese Patent Application No. 2019-090089 filed on May 10, 2019 including the specification, drawings and abstract is incorporated herein by reference in its entirety.

### BACKGROUND

### 1. Technical Field

The disclosure relates to an information providing device and an information providing program.

### 2. Description of Related Art

In the related art, a technique of providing charging equipment (a charging facility) to a motor-driven vehicle in which a high-voltage battery driving a main electric motor for traveling is mounted such that the motor-driven vehicle can arrive at a destination is known. For example, Japanese Patent Application Publication No. 2011-158322 (JP 2011-158322 A) discloses a technique of enabling use of charging equipment which is provided in a route to a destination, charging equipment which is installed in the vicinity of the destination, and the like as candidates for power supply equipment at the time of staying at the destination.

### SUMMARY

Here, when charging equipment is provided at a destination and a vehicle arrives at the destination in a state in which a residual battery capacity has decreased to a certain extent (in a state in which a state of charge of a battery is relatively low), the state of charge of the battery can be recovered before the vehicle having arrived at the destination starts movement the next time. Accordingly, it is possible to take measures such as advancing an arrival time of a vehicle at a destination or shortening a guidance route to a destination. On the other hand, when charging equipment is not provided at a destination and a vehicle arrives at the destination in a state in which the state of charge of the battery is relatively low, the state of charge of the battery may not be recovered at the destination and a moving range at the time of movement the next time is likely to be restricted. In the related art disclosed in JP 2011-158322 A, charging equipment on a route to a destination, charging equipment which is installed in the vicinity of the destination, and the like can be provided. However, in such a type of related art, there is room for improvement in providing information on charging equipment at the time of movement to a destination depending on whether charging equipment is installed at the destination.

The disclosure is directed to improvement in a manner of providing information on charging equipment at the time of movement to a destination.

An information providing device according to an embodiment of the disclosure includes a destination setting unit configured to set a destination of a motor-driven vehicle based on an input operation of a user of the motor-driven vehicle. The information providing device includes a charging equipment retrieving unit configured to retrieve whether there is charging equipment by which the motor-driven vehicle is able to be charged at the destination. The information providing device includes a route providing unit configured to change a route on which the motor-driven vehicle moves to the destination depending on whether there is charging equipment at the destination and to provide the route to the user of the motor-driven vehicle.

According to this configuration, it is possible to change a manner of providing information on charging equipment at the time of movement to a destination depending on whether there is charging equipment at the destination. Accordingly, for example, when there is no charging equipment at a destination, information on charging equipment closest to the destination as a transit point can be provided in preference to other conditions such as early arrival or a short route such that a battery is substantially fully charged at the time of start of movement the next time. When there is charging equipment at a destination, information on charging equipment as a transit point can be provided with priority given to other conditions such as early arrival or a short route such that the motor-driven vehicle does not depart from a route defined based on the other conditions even when charging is required while moving to the destination. Accordingly, a user of the motor-driven vehicle can make a driving plan with ease and enjoy a drive with ease.

The route providing unit according to the embodiment of the disclosure may include a first route providing unit configured to select a route in which a moving distance of the motor-driven vehicle to the destination is the shortest out of a plurality of routes and to provide the selected route when there is charging equipment at the destination.

According to this configuration, when it is determined that the motor-driven vehicle can travel to a destination without charging a battery during movement to a destination in which there is charging equipment, or the like, it is possible to provide a route in which a moving distance to the destination is the shortest for the purpose of giving priority to an arrival time at the destination. Accordingly, it is possible to arrive at the destination earlier than in a case in which a route in which other charging equipment is provided is selected and to charge the vehicle at the destination. Since an increase in power consumption of a battery can be curbed by selecting a route in which a moving distance is the shortest, it is possible to decrease a charging time when the vehicle arrives at the destination. Since an amount of charging and discharging of the battery is reduced, it is possible to increase a lifespan of the battery.

The route providing unit according to the embodiment of the disclosure may include a second route providing unit configured to select a route in which a moving time of the motor-driven vehicle to the destination is the shortest out of a plurality of routes and to provide the selected route when there is charging equipment at the destination.

According to this configuration, when it is determined that the motor-driven vehicle can travel to a destination without charging a battery during movement to a destination in which there is charging equipment, or the like, it is possible to provide a route in which a moving time to the destination is the shortest for the purpose of giving priority to an arrival time at the destination. Accordingly, it is possible to arrive at the destination earlier than in a case in which a route in which other charging equipment is provided is selected and to charge the vehicle at the destination. Since an increase in power consumption of a battery can be curbed by selecting a route in which a moving distance is the shortest, it is possible to decrease a charging time when the vehicle arrives at the destination. Since an amount of charging and discharging of the battery is reduced, it is possible to increase a lifespan of the battery.

The route providing unit according to the embodiment of the disclosure may include a third route providing unit configured to select a route including a place at which the charging equipment closest to the destination is provided out of a plurality of routes in which a moving distance of the motor-driven vehicle to the destination is longer than the moving distance of the motor-driven vehicle to the destination when there is charging equipment at the destination and to provide the selected route when there is no charging equipment at the destination.

According to this configuration, even when charging equipment is not provided at a destination, a route including a place in which charging equipment closest to the destination is provided can be provided and thus it is possible to decrease a travel distance from the closest charging equipment and to allow the vehicle to arrive at the destination in a state of having a large residual battery capacity. Accordingly, even when the vehicle travels on the next day after the vehicle has arrived at the destination in which there is no charging equipment or the like, it is possible to move to a next destination without paying attention to the residual battery capacity.

The route providing unit according to the embodiment of the disclosure may include a fourth route providing unit configured to select a route including a place in which the charging equipment closest to the destination is provided out of a plurality of routes in which an arrival time of the motor-driven vehicle at the destination is later than the arrival time of the motor-driven vehicle at the destination when there is charging equipment at the destination and to provide the selected route when there is no charging equipment at the destination.

According to this configuration, even when charging equipment is not provided at a destination, a route including a place in which charging equipment closest to the destination is provided can be provided and thus it is possible to decrease a travel distance from the closest charging equipment and to allow the vehicle to arrive at the destination in a state of having a large residual battery capacity. Accordingly, even when the vehicle travels on the next day after the vehicle has arrived at the destination in which there is no charging equipment or the like, it is possible to move to a next destination without paying attention to the residual battery capacity. Since the vehicle can stop over at charging equipment which is provided closest to the destination with respect to an arrival time, a user can easily predict the arrival time at the destination. When a delay time from a scheduled time is small, the user can drive with priority given to safety even when a slight delay is caused, and thus it is possible to improve security for a driver, pedestrians, and the like.

Another embodiment of the disclosure can be realized as an information providing program.

According to the disclosure, it is possible to improve a manner of providing information on charging equipment at the time of movement to a destination.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating a configuration of a traffic state information collecting system 1 including an information providing device according to an embodiment of the disclosure;

FIG. 2A is a diagram illustrating an example of a hardware configuration of an ECU 11 of an onboard device 30;

FIG. 2B is a diagram illustrating an example of a hardware configuration of a central server 20;

FIG. 3 is a diagram illustrating an example of a processing function of the ECU 11 of the onboard device 30;

FIG. 4 is a diagram illustrating an example of a configuration of a route providing unit 327;

FIG. 5 is a flowchart illustrating an operation of changing a stopover point (a route) depending on whether charging equipment is provided at a destination;

FIG. 6A is a first diagram illustrating an example of an operation of providing a place in which charging equipment closest to a destination as a transit point is provided when charging equipment is not provided at the destination;

FIG. 6B is a second diagram illustrating an example of an operation of providing a place in which charging equipment closest to a destination as a transit point is provided when charging equipment is not provided at the destination;

FIG. 6C is a third diagram illustrating an example of an operation of providing a place in which charging equipment closest to a destination as a transit point is provided when charging equipment is not provided at the destination;

FIG. 7A is a first diagram illustrating another example of an operation of providing a place in which charging equipment closest to a destination as a transit point is provided when charging equipment is not provided at the destination;

FIG. 7B is a second diagram illustrating another example of an operation of providing a place in which charging equipment closest to a destination as a transit point is provided when charging equipment is not provided at the destination; and

FIG. 7C is a third diagram illustrating another example of an operation of providing a place in which charging equipment closest to a destination as a transit point is provided when charging equipment is not provided at the destination.

### DETAILED DESCRIPTION OF EMBODIMENTS

Hereinafter, an embodiment of the disclosure will be described with reference to the accompanying drawings.

### Embodiment

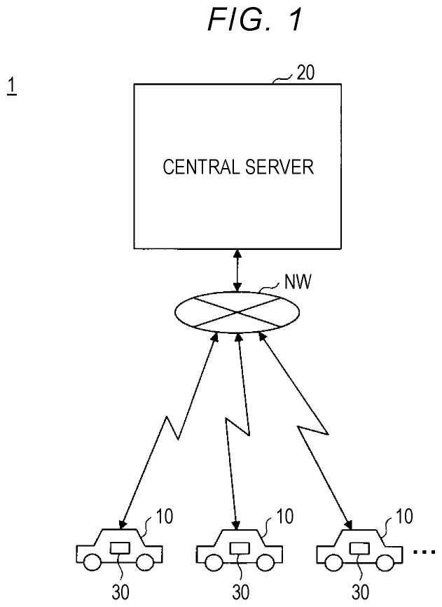

FIG. 1 is a diagram schematically illustrating a configuration of a traffic state information collecting system 1 including an information providing device according to an embodiment of the disclosure. An information providing device is, for example, an electronic control unit (ECU) which is an example of a computer constituting an onboard device 30 which is mounted in each vehicle 10. In the following description, an information providing device which is embodied by an ECU of an onboard device 30 will be described, but the information providing device is not limited to an ECU of an onboard device 30, and may be embodied, for example, by a computer constituting a navigation device which is provided in a vehicle 10 or by a computer constituting a central server 20.

A traffic state information collecting system 1 includes a plurality of vehicles 10 and a central server 20. At least one of the plurality of vehicles 10 is a motor-driven vehicle such as an electric vehicle (EV) or a hybrid vehicle (HEV, PHEV) in which a high-voltage battery that drives a main electric motor for traveling is mounted. In the following description, a vehicle 10 may be simply referred to as a “vehicle” or a “car.” A vehicle is not limited to an automobile and may be a truck or a shared vehicle (for example, a bus).

The central server 20 is a server that provides various services by collecting traffic conditions information which is transmitted from the plurality of vehicles 10 and transmitting information to users of the plurality of vehicles. The services include, for example, a carsharing service, an authentication key service, a trunk delivery service, and a B2C carsharing service.

Traffic conditions information is information on traffic conditions which are acquired by the vehicles 10. The traffic conditions information includes information on the number of vehicles 10 constituting a vehicle group which is traveling subsequently with a relatively short inter-vehicle distance, for example, at one or more prescribed target points, information on vehicle speeds of the vehicles 10 included in a vehicle group (hereinafter referred to as “vehicle speed information”), information on destinations of the vehicles 10 included in a vehicle group (hereinafter referred to as “destination information”), vehicle state information indicating vehicle states of the vehicles 10, and position information indicating positions of the vehicles.

A target point refers to a point in which congestion is likely to occur such as a sag part or a merging part of an expressway. Information indicating a target point may be set by the central server 20 and be transmitted to the plurality of vehicles 10 via a communication network NW.

A vehicle 10 is communicatively connected to the central server 20 via the communication network NW. The vehicle 10 uploads (transmits) traffic conditions information at a target point to the central server 20. The communication network NW is, for example, a mobile phone network with a plurality of base stations as terminations, a satellite communication network using communication satellites, or an Internet network.

The central server 20 (an example of an external device of the vehicle 10) is communicatively connected to the plurality of vehicles 10 via the communication network NW. The central server 20 receives traffic conditions information at a target point which is transmitted from the vehicles 10 and ascertains traffic conditions at the target point or predicts traffic conditions in the future at another target point based on the received traffic conditions information. The central server 20 may transmit the result of ascertainment of traffic conditions at the target point, the result of prediction of traffic conditions at the target point in the future, or the like to some or all of the plurality of vehicles 10.

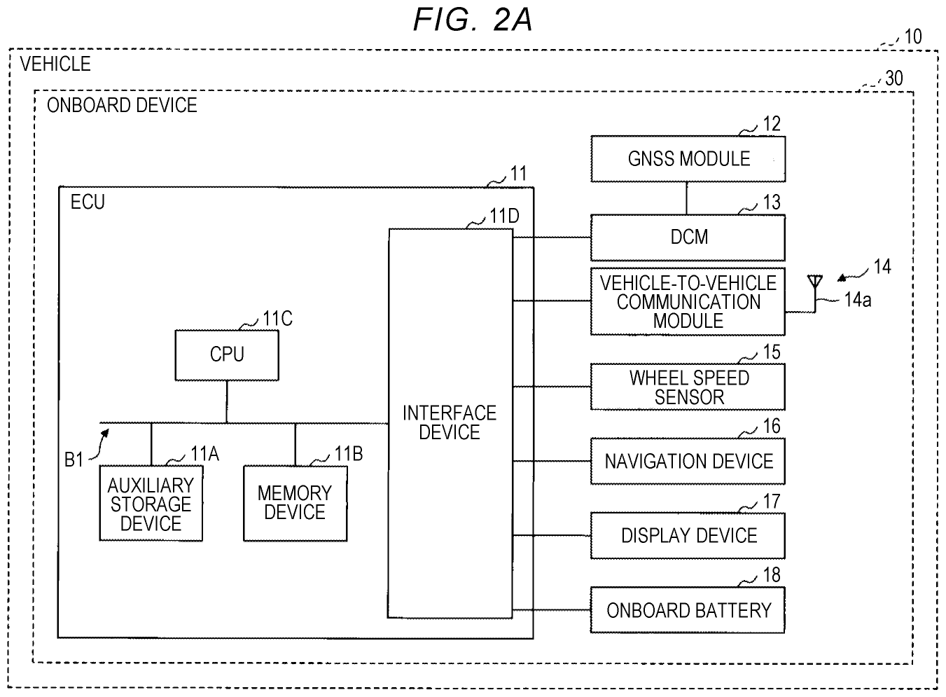

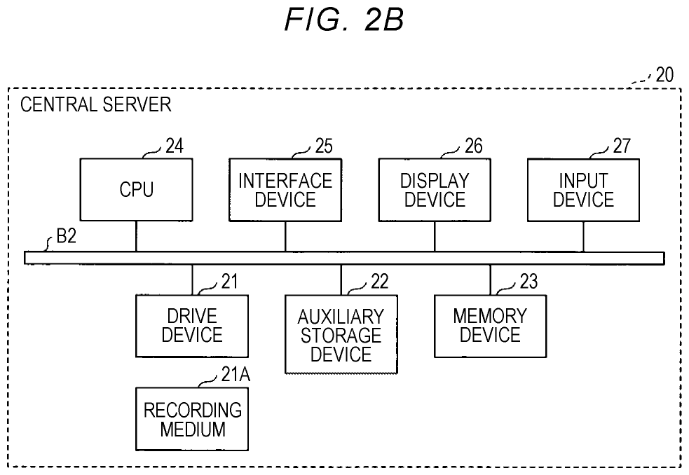

The configuration of the onboard device 30 of the vehicle 10 and the configuration of the central server 20 will be described below with reference to FIGS. 2A and 2B and the like.

FIG. 2A is a diagram illustrating an example of a hardware configuration of an ECU 11 of the onboard device 30. As illustrated in FIG. 2A, the onboard device 30 includes an ECU 11, a global navigation satellite system (GNSS) module 12, a data communication module (DCM) 13, a vehicle-to-vehicle communication module 14, a wheel speed sensor 15, a navigation device 16, a display device 17, and an onboard battery 18. In addition to such an onboard device 30, for example, an audio device, an inverter, a motor, and auxiliary machinery are mounted in the vehicle 10. The auxiliary machinery includes an air conditioner, a radiator fan, and a rear defogger.

The ECU 11 (an example of a vehicle control device) is an electronic control unit that performs various types of control for the vehicle 10 and examples thereof include a motor ECU, a hybrid ECU, and an engine ECU. The functions of the ECU 11 may be realized by arbitrary hardware or a combination of hardware and software.

The ECU 11 is constituted by a microcomputer including an auxiliary storage device 11A, a memory device 11B, a central processing unit (CPU) 11C, and an interface device 11D. The auxiliary storage device 11A, the memory device 11B, the CPU 11C, and the interface device 11D are connected to each other via a bus line B1.

A program which realizes various functions of the ECU 11 is provided, for example, by a dedicated tool which is connected by a cable which can be attached and detached to and from a predetermined external connection connector (for example, a data link coupler (DLC)) which is connected to an onboard network such as a controller area network (CAN) of the vehicle 10. The program is installed in the auxiliary storage device 11A of the ECU 11 from the dedicated tool via the cable, the connector, and the onboard network in response to a predetermined operation of the dedicated tool. The program may be downloaded from another computer (for example, the central server 20) via the communication network NW and installed in the auxiliary storage device 11A.

The auxiliary storage device 11A is a nonvolatile storage unit, and stores the installed program and required files, data, or the like. The auxiliary storage device 11A is, for example, a hard disk drive (HDD) or a flash memory.

The memory device 11B reads a program from the auxiliary storage device 11A and stores the read program when an instruction to start the program is issued.

The CPU 11C executes a program stored in the memory device 11B to realize various functions of the ECU 11 in accordance with the program.

The interface device 11D is used, for example, as an interface for connection to the onboard network or connection to various sensors, actuators, and the like in a one-to-one correspondence manner. The interface device 11D may include interface devices of a plurality of different types depending on targets which are connected thereto.

The ECU 11 controls, for example, the vehicle-to-vehicle communication module 14 such that it performs vehicle-to-vehicle communication with another vehicle 10 preceding the vehicle 10 or another vehicle 10 following the vehicle 10 via the vehicle-to-vehicle communication module 14.

The ECU 11 controls, for example, the DCM 13 such that it communicates with the central server 20 via the communication network NW.

The GNSS module 12 measures the position of the vehicle 10 (the host vehicle) in which it is mounted by receiving satellite signals which are transmitted from three or more, preferably four or more, satellites in the sky over the vehicle 10. Positioning information from the GNSS module 12, that is, position information of the vehicle 10, is received by the ECU 11, for example, via the DCM 13 and the onboard network.

The DCM 13 is a communication device which is connected to the communication network NW and which communicates with an external device including the central server 20 via the communication network NW. The DCM 13 transmits and receives various signals (for example, an information signal, a control signal, and position information) to and from the central server 20. The DCM 13 is communicatively connected to the ECU 11 via a one-to-one communication line or the onboard network such as the CAN and transmits various signals to the outside of the vehicle 10 (the host vehicle) or outputs a signal received from the outside of the vehicle 10 to the ECU 11 in response to a request from the ECU 11.

The vehicle-to-vehicle communication module 14 (an example of a first communication unit and a second communication unit) is an existing communication device that performs radio communication between a plurality of vehicles 10 using radio waves of a radio frequency (FR) band (for example, a 700 MHz band or a 5.8 GHz band). The vehicle-to-vehicle communication module 14 may use radio waves of a millimeter wave band (for example, a 60 GHz band) or a quasi-millimeter wave band (for example, a 24 GHz band). The vehicle-to-vehicle communication module 14 includes a directional antenna 14a.

The directional antenna 14a can radiate radio waves such that the radio field intensity in a specific direction when seen from the vehicle 10, specifically, the radio field intensity in the forward direction or the rearward direction of the vehicle 10, is strong and the radio field intensity in other directions is limited to being very weak. Similarly, the directional antenna 14a may receive radio waves from the outside such that the reception sensitivity in a specific direction when seen from the vehicle 10, specifically, the reception sensitivity in the forward direction or the rearward direction of the vehicle 10, is strong and the reception sensitivity in other directions is limited to being very weak.

Accordingly, the vehicle-to-vehicle communication module 14 can set up vehicle-to-vehicle communication with another vehicle 10 preceding the vehicle 10 or another vehicle 10 following the vehicle 10 under the control of the ECU 11.

The directional antenna 14a adjusts the radio field intensity thereof such that radio waves which can be received by the vehicle-to-vehicle communication module 14 of another vehicle 10 reach a predetermined distance (hereinafter referred to as a “communication range”) in front of or to the rear of the vehicle 10. Here, the communication range is prescribed using a value corresponding to an upper limit of an inter-vehicle distance between the vehicles 10 in a situation in which traffic conditions of a road on which the vehicles 10 travel are relatively congested. The communication range is, for example, about 10 meters. Accordingly, the vehicle-to-vehicle communication module 14 can set up communication between the vehicles 10 which are subsequent in the front-rear direction only when the inter-vehicle distance between the vehicles 10 is relatively short under the control of the ECU 11.

The front communication range of the vehicle 10 and the rear communication range of the vehicle 10 may be equal to or different from each other. The directional antenna 14a may include a directional antenna for communication with another vehicle 10 preceding the vehicle 10 and a directional antenna for communication with another vehicle 10 following the vehicle 10. Similarly, the vehicle-to-vehicle communication module 14 may include a vehicle-to-vehicle communication module (an example of a second communication unit) for communication with another vehicle 10 preceding the vehicle 10 and a vehicle-to-vehicle communication module (an example of a first communication unit) for communication with another vehicle 10 following the vehicle 10.

The wheel speed sensor 15 is an existing detection unit that detects a wheel speed of each wheel of the vehicle 10. The wheel speed sensor 15 outputs detection information (hereinafter referred to as “wheel speed information”) corresponding to the wheel speed of each wheel. The wheel speed information is received by the ECU 11 via a one-to-one communication line or an onboard network. Accordingly, the ECU 11 can detect (derive) a vehicle speed of the vehicle 10 based on the wheel speed information of the vehicle 10.

The navigation device 16 performs provision of or guidance on a route to a destination which is set by a user of the vehicle 10 (specifically, a driver or a fellow passenger) using speech or display or a destination which is automatically set. Here, a destination which is automatically set includes, for example, a destination which is predicted from a movement pattern based on past movement history of the user. Here, the destination which is automatically set may be a destination which is predicted by the navigation device 16 or may be a destination which is predicted by an external navigation server capable of communicating and which is downloaded via the DCM 13. Destination information which is stored by the navigation device 16 is received by the ECU 11 via an onboard network or the like.

The display device 17 is, for example, a touch panel type liquid crystal display. The display device 17 is disposed at a position which is visible to an occupant such as a driver of the vehicle 10, for example, an upper part of the center of an instrument panel of a passenger compartment, and displays various information screens or various operation screens under the control of the ECU 11.

FIG. 2B is a diagram illustrating an example of a hardware configuration of the central server 20. The functions of the central server 20 may be realized by arbitrary hardware or by a combination of hardware and software. As illustrated in FIG. 2B, for example, the central server 20 includes a drive device 21, an auxiliary storage device 22, a memory device 23, a CPU 24, an interface device 25, a display device 26, and an input device 27 which are connected to a bus B2.

A program which realizes various functions of the central server 20 is provided, for example, by a recording medium 21A. The recording medium 21A is a portable memory such as a compact disc read only memory (CD-ROM), a digital versatile disc read only memory (DVD-ROM), or a universal serial bus (USB) memory. When the recording medium 21A on which a program is recorded is set in the drive device 21, the program is installed in the auxiliary storage device 22 from the recording medium 21A via the drive device 21. The program may be downloaded from another computer via the communication network and installed in the auxiliary storage device 22.

The auxiliary storage device 22 stores various programs which are installed and stores necessary files or data.

When an instruction to start a program is issued, the memory device 23 reads the program from the auxiliary storage device 22 and stores the read program.

The CPU 24 executes various programs stored in the memory device 23 and realizes various functions associated with the central server 20 in accordance with the programs.

The interface device 25 is used as an interface for connection to a communication network (for example, the communication network NW).

The display device 26 displays a graphical user interface (GUI), for example, in accordance with a program which is executed by the CPU 24.

The input device 27 is used to allow an operator or manager of the central server 20 or the like to input various operation instructions associated with the central server 20.

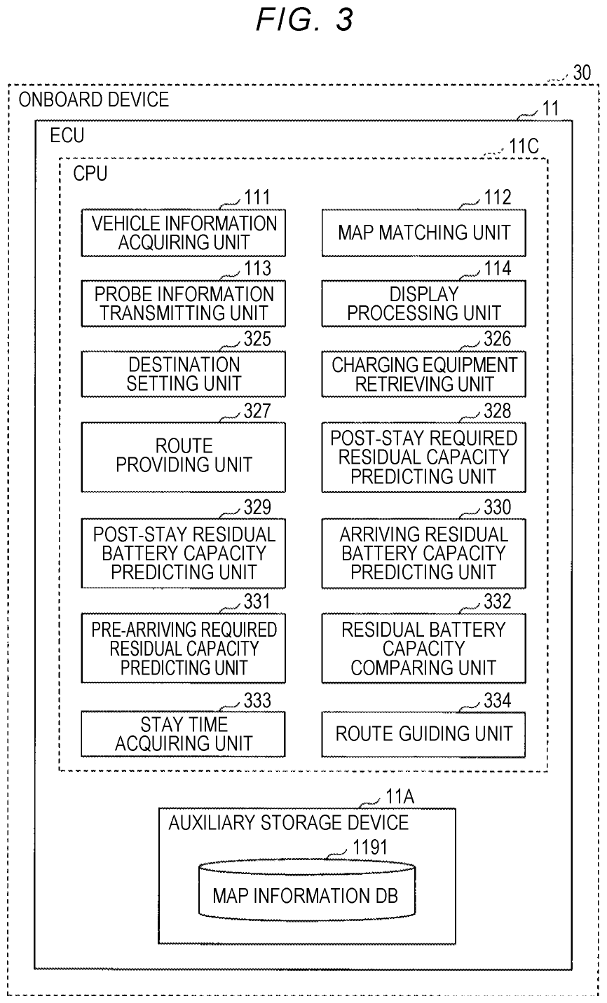

Processing functions of the ECU 11 of the onboard device 30 will be described below with reference to FIG. 3.

FIG. 3 is a diagram illustrating a configuration example of processing functions of the ECU 11 of the onboard device 30. The CPU 11C of the ECU 11 includes a vehicle information acquiring unit 111, a map matching unit 112, a probe information transmitting unit 113, a display processing unit 114, a destination setting unit 325, a charging equipment retrieving unit 326, a route providing unit 327, a post-stay required residual capacity predicting unit 328, a post-stay residual battery capacity predicting unit 329, an arriving residual battery capacity predicting unit 330, a pre-arriving required residual capacity predicting unit 331, a residual battery capacity comparing unit 332, a stay time acquiring unit 333, a route guiding unit 334.

These functions are realized by causing the CPU 11C to execute programs which are stored in the memory device 11B or the auxiliary storage device 11A illustrated in FIG. 2A. The auxiliary storage device 11A includes, for example, a map information database (DB) 1191.

The map information DB 1191 is a database in which point information is retrievably accumulated and is constituted by geographic information system (GIS) data or the like. The GIS data is data including nodes corresponding to crossings, road links that connect the nodes, lines corresponding to objects such as buildings or roads, and polygons corresponding to objects such as buildings or roads.

The point information includes information associated with charging equipment (charging equipment information) and an average stay time of users for each piece of point information in addition to names, addresses, position information, and attribute information of the points.

It is preferable that the charging equipment information be managed by, for example, the central server 20 and appropriately updated by communication with the central server 20. Since the charging equipment information has a high possibility of change, it is preferable that the charging equipment information be acquired directly from the central server 20 in principles. Particularly, information with high real-time characteristics such as equipment availability information or reservation information is preferably acquired directly from the central server 20.

In addition to information indicating whether there is charging equipment, the charging equipment information may include a power supply mode using charging equipment, a standard, power supply capability (whether quick charging is possible), equipment availability information, and reservation information when there is charging equipment.

The power supply mode using charging equipment includes classifications such as an electromagnetic induction system, a magnetic field resonance system, and a microwave power supply system in addition to a classification of whether the mode is a wireless power supply system or a wired power supply system. For example, when wireless power supply is performed using a coil, the standard includes information such as installation positions of the coil in a parking space, a movable range of the coil, a diameter of the coil, and a resonance frequency.

In the map information DB 1191, a plurality of facility candidates which can be set by the destination setting unit 325 is correlated with the charging equipment information.

The vehicle information acquiring unit 111 acquires vehicle information which is input from the GNSS module 12, the wheel speed sensor 15, and various other sensors illustrated in FIG. 1 from a buffer in the RAM or the like. Specifically, the vehicle information acquiring unit 111 acquires position information of the vehicle 10 which is input from the GNSS module 12. The vehicle information acquiring unit 111 acquires wheel speed information which is input from the wheel speed sensor 15. The vehicle information acquiring unit 111 acquires a residual battery capacity at the current time (a processing time point by the CPU 11C) from a charging/discharging control device of an onboard battery 18 which is mounted in the vehicle.

The map matching unit 112 identifies a road link corresponding to the position information of the vehicle 10, that is, a road link in which the vehicle 10 is currently located, based on information stored in the map information DB 1191 and the position information of the vehicle 10 acquired by the vehicle information acquiring unit 111. For example, since a link identifier (ID) is defined in advance for each of a plurality of road links constituting a road network included in the map information DB 1191, the map matching unit 112 identifies a link ID of a road link in which the vehicle 10 is currently located with reference to the map information DB 1191.

The function of the map matching unit 112 may be provided in the central server 20. In this case, the central server 20 can identify a link ID of a road link in which each vehicle 10 is currently located based on position information included in probe information which will be described later and which is transmitted from the vehicles 10.

The probe information transmitting unit 113 generates probe information including various types of vehicle information acquired by the vehicle information acquiring unit 111, time information corresponding to the vehicle information, and a road link identified by the map matching unit 112 at intervals of a predetermined period. The probe information transmitting unit 113 transmits the generated probe information to the central server 20 via the DCM 13.

The probe information which is transmitted from the vehicle 10 to the central server 20 may not include the time information corresponding to various types of vehicle information. In this case, the central server 20 can add a time at which vehicle movement information is transmitted from a vehicle 10, a time at which vehicle movement information is received by the central server 20, or a time at which the vehicle 10 is estimated to be located at an actual position corresponding to the position information and which is calculated from the above-mentioned times as time information corresponding to various types of vehicle information to the probe information which is received from the vehicle 10.

The display processing unit 114 performs a process of displaying a predetermined information screen on the display device 17 in response to an operation by an occupant such as driver of the vehicle 10. For example, the display processing unit 114 performs a process of displaying various types of information which is transmitted from the central server 20 to the vehicle 10 on the display device 17.

The destination setting unit 325 sets a destination of a vehicle based on a user's input operation. Examples of the user's input operation include a touch input operation on the display device 17 or a speech input operation. For example, in case of the speech input operation, when speech details for starting setting of a destination, for example, “retrieve a destination,” is detected by a sound collecting unit provided in the vehicle, the detected speech details are converted into speech information and the speech information is input to the destination setting unit 325. The destination setting unit 325 reads message information which is stored in the auxiliary storage device 11A in advance, converts message information for setting a destination such as “where is a destination?” into speech information, and outputs the speech information from an onboard speaker or the like. When a response such as “XX Hot Spring in Atami” to the question is returned by a user, the speech details are detected by the sound collecting unit, the detected speech details are converted into speech information, and the speech information is input to the destination setting unit 325. The destination setting unit 325 analyzes frequency components included in the speech information, analyzes the speech details, sets a destination, and calculates a route from the current location to the set destination. A method of analyzing speech details from speech information is known as disclosed in Japanese Patent Application Publication No. 2015-211403 (JP 2015-211403 A), Japanese Patent Application Publication No. 2018-156523 (JP 2018-156523 A), and the like and thus description thereof is omitted.

The charging equipment retrieving unit 326 retrieves whether there is charging equipment with which a vehicle can be charged at the destination set by the destination setting unit 325. For example, when a destination is set by the destination setting unit 325, the charging equipment retrieving unit 326 refers to the map information DB 1191. By referring to the map information DB 1191, the charging equipment retrieving unit 326 ascertains whether charging equipment corresponding to specifications of a charging/discharging device of the vehicle (specifications of a charging/discharging device that performs charging/discharging control of a battery, or the like). That is, the charging equipment retrieving unit 326 retrieves charging equipment that satisfies the specifications of the charging/discharging device. The specifications of the charging/discharging device include a power supply mode, a standard, a power supply capability (whether quick charging is possible), a wireless power supply system, and a wired power supply system.

A range in which the charging equipment retrieving unit 326 retrieves charging equipment may be a site of a shopping mall, for example, when the destination is the large shopping mall with a large site area or may be an area which can be considered to be the same as the destination. Regarding the area which can be considered to be the same as the destination, for example, when the destination is a small hotel and a parking lot of the hotel in which charging equipment is installed is separated about 100 m from the hotel, an area including the hotel and the parking lot is considered as the area which can be considered to be the same as the destination.

When it has been retrieved whether there is charging equipment with which a vehicle can be charged at the destination set by the destination setting unit 325, the charging equipment retrieving unit 326 may informs a user of the result of retrieval via the display device 17, a speaker, or the like. For example, when it is retrieved that there is charging equipment corresponding to the specifications of the charging/discharging device of the vehicle at the destination, the charging equipment retrieving unit 326 may display a text message such as “charging is possible at the destination” on the screen of the display device 17 or may display specifications of the charging equipment (for example, a connection standard such as CHAdeMO (registered trademark)) as a text message. The charging equipment retrieving unit 326 may display a text message such as “There is no charging equipment at the destination. May a stopover facility or the like be retrieved?” on the screen of the display device 17 when there is no charging equipment corresponding to the specifications of the charging/discharging device of the vehicle at the destination, or may display a text message such as “Charging at the destination is not possible,” when the specifications of the charging equipment do not match.

For example, when two or three pieces of charging equipment are installed at a destination such as a department store or a recreation area, there is a high possibility that any thereof is being used by another user around a scheduled arrival time in a situation in which about several tens of minutes elapses from start of charging. The charging equipment retrieving unit 326 acquires newest information on the number of pieces of charging equipment acquired via the central server 20, an operating state of charging equipment, an operating time of charging equipment, and specifications thereof. Accordingly, even when charging equipment is provided at the destination, it is predicted that there is a high possibility that the charging equipment will be used by another user around the scheduled arrival time. When the result of prediction is the same as in this way, the charging equipment retrieving unit 326 considers that there is no charging equipment provided at the destination and inputs information indicating that there is no charging equipment with which a vehicle can be charged at the destination to the route providing unit 327. Accordingly, the route providing unit 327 can provide a route including a place in which the vehicle is chargeable in the vicinity of the destination in which no charging equipment is considered to be provided. As a result, a route including a place in which charging equipment with a high possibility of charging is installed can be provided to a user with an intention of charging at the destination, and the user can make a moving plan with ease.

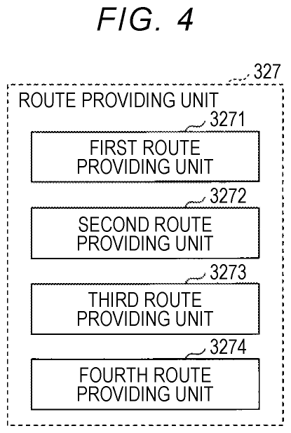

The route providing unit 327 changes a route on which the vehicle moves to the destination and provides the changed route to the user of the vehicle based on the result of retrieval from the charging equipment retrieving unit 326, that is, depending on whether there is charging equipment chargeable at the destination. The method of providing a route to a user is performed by causing the display device 17 to display a moving route of the vehicle from the current location to the destination when there is charging equipment at the destination and causing the display device 17 to display a moving route of the vehicle from the current location to the destination (including a bypass route) when there is no charging equipment at the destination. An example of the configuration of the route providing unit 327 will be described below with reference to FIG. 4.

FIG. 4 is a diagram illustrating an example of the configuration of the route providing unit 327. The route providing unit 327 includes a first route providing unit 3271, a second route providing unit 3272, a third route providing unit 3273, and a fourth route providing unit 3274.

When there is charging equipment at the destination, the first route providing unit 3271 selects a route in which a moving distance to the destination is the shortest out of a plurality of routes and provides the selected route. Specifically, for example, when predetermined determination is performed based on the results of calculation of the arriving residual battery capacity predicting unit 330, the pre-arriving required residual capacity predicting unit 331, the residual battery capacity comparing unit 332, and the like with reference to the map information DB 1191, the first route providing unit 3271 provides a route in which a moving distance to the destination is the shortest for the purpose of giving priority to an arrival time at the destination (shortening the time). Examples of the case in which the predetermined determination is performed include a case in which it is determined that the vehicle can travel to the destination without charging the vehicle during movement to the destination in which there is charging equipment and a case in which there is charging equipment in the vicinity of a moving route and thus it is determined that the vehicle can depart from the moving route and pass through the charging equipment in several to several tens of minutes.

The first route providing unit 3271 calculates a route in consideration of newest road traffic conditions, driving conditions of the vehicle, and the like. For example, when there is a high possibility that the residual battery capacity will be zero until the vehicle arrives at the destination under a predetermined situation, the first route providing unit 3271 determines whether there is charging equipment in the current moving route, and provides a stopover route passing through a place in which there is charging equipment when it is determined that there is charging equipment. When there is no charging equipment in the current moving route, the first route providing unit 3271 retrieves a plurality of bypass routes in which there is charging equipment, selects a route in which a moving distance is the shortest, and provides the selected route to the user. Examples of the predetermined situation include a case in which a traffic accident or the like occurs during movement to the destination and thus chronic traffic congestion with an average speed of 5 km/h occurs, a case in which the vehicle travels at a speed of 100 km/h on an expressway, a case in which the vehicle travels on a mountain road in which uphill roads are consecutive, and a case in which low-speed travel is inevitable due to a sudden snowfall.

Even when it is determined that the vehicle can travel to the destination without charging the vehicle during movement to the destination in which there is charging equipment, the first route providing unit 3271 provides a route in which the moving distance to the destination is the shortest for the purpose of giving priority to an arrival time at the destination. Accordingly, it is possible to arrive at the destination earlier in comparison with a case in which a route in which other charging equipment is provided is selected and to charge the vehicle at the destination. Since an increase in power consumption of the battery can be curbed by selecting a route in which the moving distance is the shortest, it is possible to decrease a charging time at the time of arriving at the destination. Since an amount of charging and discharging of the battery is curbed, it is possible to extend a lifespan of the battery.

The route providing unit 327 may be configured to select a route in which a moving time to the destination is the shortest and to provide the selected route instead of the route in which the moving distance to the destination is the shortest when there is charging equipment at the destination. The second route providing unit 3272 of the route providing unit 327 selects a route in which the moving time of the vehicle to the destination is the shortest out of the plurality of routes and provides the selected route when there is charging equipment at the destination. Specifically, for example, when predetermined determination is performed based on the results of calculation from the arriving residual battery capacity predicting unit 330, the pre-arriving required residual capacity predicting unit 331, the residual battery capacity comparing unit 332, and the like, the second route providing unit 3272 selects and provides a route in which the moving time to the destination is the shortest for the purpose of giving priority to an arrival time at the destination (shortening the time). Examples of the case in which the predetermined determination is performed include a case in which it is determined that the vehicle can travel to the destination without charging the vehicle during movement to the destination in which there is charging equipment and a case in which there is charging equipment in the vicinity of a moving route and thus it is determined that the vehicle can depart from the moving route and pass through the charging equipment in several to several tens of minutes.

Similarly to the first route providing unit 3271, the second route providing unit 3272 selects a route in consideration of newest road traffic conditions, driving conditions of the vehicle, and the like. For example, when chronic traffic congestion occurs during movement to the destination, the second route providing unit 3272 determines whether there is charging equipment in the current moving route, and provides a stopover route passing through a place in which there is charging equipment when it is determined that there is charging equipment. When there is no charging equipment in the current moving route, the second route providing unit 3272 retrieves a plurality of bypass routes in which there is charging equipment, selects a route in which the moving time is the shortest, and provides the selected route to the user.

Even when it is determined that the vehicle can travel to the destination without charging the vehicle during movement to the destination in which there is charging equipment, the second route providing unit 3272 provides a route in which the moving time to the destination is the shortest for the purpose of giving priority to an arrival time at the destination. Accordingly, it is possible to arrive at the destination earlier in comparison with a case in which a route in which other charging equipment is provided is selected and to charge the vehicle at the destination. Since an increase in power consumption of the battery can be curbed by selecting a route in which the moving time is the shortest, it is possible to decrease a charging time at the time of arriving at the destination. Since an amount of charging and discharging of the battery is curbed, it is possible to extend a lifespan of the battery.

When there is no charging equipment at the destination, the third route providing unit 3273 selects a route including a place in which charging equipment closest to the destination is provided out of a plurality of routes in which the moving distance of the vehicle to the destination is longer than the moving distance of the vehicle to the destination when there is charging equipment at the destination and provides the selected route to the user. For example, when the destination is a destination (such as a hotel) in which charging equipment is not provided, the third route providing unit 3273 determines whether there is charging equipment in the moving route to the destination based on the results of calculation from the arriving residual battery capacity predicting unit 330, the pre-arriving required residual capacity predicting unit 331, the residual battery capacity comparing unit 332, and the like with reference to the map information DB 1191, or determines whether there is charging equipment in a place of a bypass route which departs from the moving route and passes through the place in several to several tens of minutes. Then, the third route providing unit 3273 calculates a plurality of stopover routes or bypass routes passing through the place in which there is charging equipment, provides the routes to the user, and provides one route including the place in which charging equipment closest to the destination is provided out of the routes to the user, for example, by emphasizing the route or attaching a message such as a recommended route thereto. By providing a route including a place in which charging equipment closest to the destination is provided, it is possible to decrease a traveling distance from the closest charging equipment and to allow the vehicle to arrive at the destination with a large residual capacity of the battery. Accordingly, for example, even when the vehicle travels on a next day of the day on which the user arrived at a hotel, the user can move to a next destination with ease without paying attention to the residual battery capacity

When a plurality of routes in which a moving distance of the vehicle to the destination is longer than the moving distance of the vehicle to the destination when there is charging equipment at the destination is calculated, for example, the third route providing unit 3273 may estimate whether an occupant of the vehicle wants to stop over a place other than the destination and provide a route in which the occupant wants to stop over the place. For example, when the set destination is “XX Hot Spring” and speech details of the occupant are “Today, we will enjoy a hot spring. May we take a break somewhere because we have plenty of time?” or “May we take lunch in a dumpling shop in District XX?,” the third route providing unit 3273 can estimate that a user wants to stop over in a place other than the hot spring using “take a break somewhere,” “dumpling shop in District XX,” and the like as key words (information indicating a place other than the destination). The intention estimating process employs, for example, an intention estimation model. An intention estimation model is a model which has learned from various sample sentences and corresponding intentions using a statistical technique and can cope with a user's various expressions using the intention estimation model. In this way, the method of estimating an intention from a user's speech details is known, for example, as disclosed in Re-publication of PCT International Publication No. 2017-168637 (WO 2017-168637).

With this configuration, even when the moving distance becomes longer, it is possible to charge the vehicle in a place in which the user wants to stop over during movement. It is possible to greatly reduce a burden of a user for retrieving a stopover facility. It is possible to provide a facility which cannot be found by a user without retrieving for a long time without departing from the purpose of movement for a short time. Accordingly, a facility in which a user has never stopped over may be found and it is thus possible to further improve pleasure of movement to a destination.

When there is no charging equipment at the destination, the fourth route providing unit 3274 selects a route including a place in which charging equipment closest to the destination is provided out of a plurality of routes in which the arrival time of the vehicle at the destination is later than the arrival time of the vehicle at the destination when there is charging equipment at the destination and provides the selected route to the user. For example, when the destination is a destination (such as a hotel) in which charging equipment is not provided, the fourth route providing unit 3274 determines whether there is charging equipment in the moving route to the destination based on the results of calculation from the arriving residual battery capacity predicting unit 330, the pre-arriving required residual capacity predicting unit 331, the residual battery capacity comparing unit 332, and the like with reference to the map information DB 1191, or determines whether there is charging equipment in a place of a bypass route which departs from the moving route and passes through the place in several to several tens of minutes. Then, the fourth route providing unit 3274 calculates a plurality of stopover routes or bypass routes passing through the place in which there is charging equipment, provides the routes to the user, and provides one route including the place in which charging equipment closest to the destination is provided out of the routes to the user, for example, by emphasizing the route or attaching a message such as a recommended route thereto.

When a plurality of routes in which the arrival time of the vehicle at the destination is later than the arrival time of the vehicle at the destination when there is charging equipment at the destination is calculated, the fourth route providing unit 3274 may estimate whether an occupant of the vehicle wants to stop over a place other than the destination and provide a route in which the occupant wants to stop over the place.

Even when there is no charging equipment at the destination, the fourth route providing unit 3274 can provide a route including a place in which charging equipment closest to the destination is provided and thus it is possible to decrease a traveling distance from the closest charging equipment and to allow the vehicle to arrive at the destination with a large residual capacity of the battery. Accordingly, for example, even when the vehicle travels on a next day of the day on which the user arrived at a destination in which there is no charging equipment, the user can move to a next destination with ease without paying attention to the residual battery capacity

With the fourth route providing unit 3274, since the vehicle can stop over the charging equipment closest to the destination based on the arrival time, a user can easily predict the arrival time at the destination. When a delay time from a scheduled time is small, the user can drive the vehicle with priority given to safety in spite of a slight delay and thus it is possible to achieve improvement in safety of a driver, pedestrians, and the like.

The route providing unit 327 may have the following configuration. The route providing unit 327 calculates a route from a current location to a destination based on the map information DB 1191, and calculates a route to the destination including a stopover facility in consideration of a desired arrival time which is a time at which a user desires to arrive at the destination, a current time, a margin time until arrival, and the alike at the time of causing the display device 17 to display the calculated route as a stopover route. Current location information includes information on a traffic volume around the current location and information on weather around the current location. The margin time is a time in which the user can stay in the stopover facility. For example, the scheduled arrival time at the time of direct movement from the current location to the destination is 13:00, and an empty time of two hours is between the scheduled arrival time and a desired arrival time when a user thinks that the user has only to arrive at the destination at 15:00. For example, when a desired arrival time is received by a touch operation of the navigation device 16 or the display device 17 or the like, the route providing unit 327 calculates an empty time, retrieves a plurality of facilities in which the vehicle can stop over in the calculated empty time, retrieves a place which is suitable for a movement purpose of the user and in which there is charging equipment, and provides a route including the place. For example, speech details of the user, set destination information which is manually set by the user, or a scheduler in which behavior records of the user are recorded are used to estimate the movement purpose of the user.

When the movement purpose is estimated from the speech details, for example, when the speech details of the user are “Today, we will enjoy a hot spring,” the movement purpose can be estimated to be sightseeing or entertainment in a place in which a hot spring gushes out based on the keyword (destination information) of “a hot spring.” That is, the route providing unit 327 estimates the movement purpose based on destination information included in the speech details of the user. By using destination information based on speech instead of destination information which is manually set by a user, a burden on the user at the time of retrieving a final destination is greatly reduced in comparison with a case in which destination information is manually input. Recently, since a speech recognition technique is advanced and speech recognition accuracy is greatly improved, the estimation of the movement purpose based on speech is more useful than estimation based on a manual input, set destination information, and a scheduler.

When a movement purpose is estimated based on the set destination information, for example, when a name of a hot spring “XX Hot Spring” is included in information of a destination set by a user, the movement purpose can be estimated to be sightseeing or entertainment in a place in which a hot spring gushes out. When a company name “XX Corporation” is included in information of a destination which is set by a user, the movement purpose can be estimated to be business with a customer.

When a movement purpose is estimated based on a scheduler, the scheduler may be a history when a user moved to a destination in the past or may be planned. For example, information such as a departure time, a movement purpose, movement to a transit point, a separation range, stopover facilities to a destination, facility features, genres of stopover facilities, a stopover time, a stay time, or whether there is a fellow passenger is included in the scheduler. This information of the scheduler is stored in the auxiliary storage device 11A or the like, and the route providing unit 327 can estimate the movement purpose with reference to the information of the scheduler.

In this way, when a movement purpose of a user is estimated, the route providing unit 327 determines candidates for an stopover facility from a departure point to a destination using the estimated movement purpose and provides a route including the determined candidates for an stopover facility. Accordingly, it is possible to move smoothly to a stopover facility while effectively using an empty time.

A margin time varies, for example, depending on a type of a road for accessing a stopover facility. Accordingly, the route providing unit 327 calculates an average travel speed when each road is used, for example, with a type of a road such as an expressway, a general road, or a bypass road as movement conditions, and calculates a margin time. The margin time may be calculated in consideration of traffic conditions such as VICS (registered trademark) in addition to a type of a road.

The processes of the route providing unit 327 can be performed in any of a forward route and a return route. For example, when a movement purpose is a tour, the final destination in a route from a home to a lodging facility (a forward route) is the lodging facility and the final destination in a route from a lodging facility to a home (a return route) is the home. Accordingly, it is possible to provide candidates for a stopover facility after the forward route has been set and to provide candidates for a stopover facility after the return route has been set.

The time at which candidates for a stopover facility are provided may be a time before the vehicle moves or may be a time at which the vehicle is moving. When the vehicle is moving, a moving time to a stopover facility varies in real time depending on a current location of the vehicle, surrounding traffic conditions, a type of a road on which the vehicle is traveling. Accordingly, the route providing unit 327 provides newest candidates for a stopover facility while sequentially updating such information at intervals of a predetermined period.

The pre-arriving required residual capacity predicting unit 331 predicts a pre-arriving required residual capacity which is a residual battery capacity required for traveling to a destination by calculating power consumption when the vehicle travels on a traveling route which is provided by the route providing unit 327. The pre-arriving required residual capacity can be most simply calculated using a method of multiplying power consumption per unit traveling distance by a distance of a retrieved route (the route which is provided by the route providing unit 327) or a method of multiplying power consumption per traveling time by a traveling time to a destination. Here, in order to calculate a more accurate pre-arriving required residual capacity, the pre-arriving required residual capacity predicting unit 331 may collect information on factors affecting power efficiency such as a gradient of a road, a time period, a season, an atmospheric temperature, congestion information, and a tendency for a driver to operate an accelerator and calculate the pre-arriving required residual capacity in consideration of such information. For example, when a certain factor affecting power efficiency is acquired by the collection of information, a coefficient can be set depending on an extent of the factor and a more accurate pre-arriving required residual capacity can be predicted using a method of correcting the pre-arriving required residual capacity. Various formats such as electric energy, time, distance, or load which is expressed in an independent format may be employed as a unit of the calculated pre-arriving required residual capacity.

The post-stay residual battery capacity predicting unit 329 predicts a post-stay residual battery capacity when the vehicle stays at a destination based on information associated with power supply capability of charging equipment which is installed at the destination, a residual battery capacity at the time of arrival at the destination, and a stay time at the destination. For example, the post-stay residual battery capacity predicting unit 329 acquires information such as power supply capability of charging equipment from the central server 20 or various pieces of charging equipment via the communication network NW and calculates to what extent an arriving residual battery capacity is recovered with the capability of the charging equipment acquired from the acquired information. When charging equipment which can perform quick charging is provided in a certain destination, an amount of power supplied per unit time at the destination increases and thus the residual battery capacity can be recovered to the post-stay required residual capacity or more even for a short stay time. The power supply capability can be expressed using a map indicating a relationship between an elapsed time from start of power supply and the residual battery capacity or the like. In this way, the post-stay residual battery capacity predicting unit 329 predicts the post-stay residual battery capacity when charging during stay has been completed.

The residual battery capacity comparing unit 332 compares the residual battery capacity which is input via the vehicle information acquiring unit 111 with the pre-arriving required residual capacity for each destination. The residual battery capacity has only to have a form which can be compared with the residual battery capacity required for reaching the destination and can be acquired, for example, in the form of a ratio with respect to a full charging capacity, a travelable time, or a travelable distance.

As for a destination which is determined to be reached with a reference residual battery capacity, the arriving residual battery capacity predicting unit 330 calculates an arriving residual battery capacity which is a residual battery capacity at the time of arrival at the destination. Specifically, the arriving residual battery capacity predicting unit 330 calculates the arriving residual battery capacity based on the reference residual battery capacity and power consumption when the vehicle travels on the route to the destination provided by the route providing unit 327. For example, when the residual battery capacity and the power consumption is expressed by a traveling time, a traveling distance, or the like, the arriving residual battery capacity can be calculated by simply subtracting the power consumption at the time of traveling to the destination from the reference residual battery capacity.

The post-stay required residual capacity predicting unit 328 predicts the post-stay required residual capacity by calculating the power consumption when the vehicle travels on a post-stay traveling route which is provided by the route providing unit 327. Specifically, the post-stay required residual capacity predicting unit 328 predicts the post-stay required residual capacity by calculating a residual battery capacity required for traveling to a next destination with charging equipment (a post-stay destination) or a destination in a series of travel schedules (for example, a final destination such as a store that rents a rental car or a home in which a private car is parked) after stay at the destination has ended and the vehicle has departed from the destination. A specific method of calculating the required residual capacity is substantially the same as calculating the residual battery capacity required for arriving at a destination by the pre-arriving required residual capacity predicting unit 331.

The stay time acquiring unit 333 acquires a pre-prepared travel schedule or the like, for example, by receiving an input from a user via the display device 17. Alternatively, the stay time acquiring unit 333 acquires a stay time at a destination by estimating the stay time based on attribute information of the destination or the like. When the stay time is acquired from the travel schedule, the stay time acquiring unit 333 can acquire the stay time by predicting a scheduled arrival time at the destination and calculating a difference from a scheduled departure time in the travel schedule. Most simply, the scheduled arrival time can be calculated by adding a traveling time, which is calculated by dividing a distance of a provided route by an average vehicle speed or the like, to the reference time (for example, the current time). A more accurate scheduled arrival time may be calculated in consideration of information based on congestion information or the like. The attribute information of a destination is information indicating attributes of a stay place which is a destination (which is preferably information from which a time in which a user will stay can be predicted). The stay time acquiring unit 333 can predict the stay time to be several hours, for example, when the destination has an attribute of a customer company and can predict the stay time to be several tens of hours when the destination has an attribute of a hotel. An average stay time of users for each piece of point information which is accumulated in the map information DB 1191, the central server 20, or the like can be used as the stay time.

The route guiding unit 334 performs travel guidance from a current location to a destination for a route which is selected by a user or a route which is automatically selected by the route providing unit 327 out of routes which are provided by the route providing unit 327, for example, using position information of a current location of the vehicle, a vehicle speed, a vehicle moving direction acquired by a gyro sensor or the like, and the map information DB 1191. The function of the route guiding unit 334 may be replaced with the navigation device 16. The route guiding unit 334 performs travel guidance for a route to a destination using a display screen, speech, or the like. The technique for route guidance is known as disclosed in Japanese Patent No. 6305664, Japanese Patent No. 6416948, and the like and thus detailed description thereof will be omitted.

An example of an operation of changing a stopover place (route) depending on whether charging equipment is provided at a destination will be described below with reference to FIG. 5 or the like. FIG. 5 is a flowchart illustrating an operation of changing a stopover place (route) depending on whether charging equipment is provided at a destination.

When a destination is set in Step S1, it is determined in Step S2 whether there is charging equipment at a destination.

When it is determined that there is charging equipment at the destination (Step S2: YES), a route from a current location to a destination is retrieved in Step S3.

In Step S3, both of a route in which a moving distance to the destination is the shortest and a route in which a moving time to the destination is the shortest out of a plurality of routes may be retrieved and provided to a user, and then one route may be allowed to be selected by the user, or one route may be automatically selected based on preset route retrieval conditions. Regarding the preset route retrieval conditions, for example, when a time-decreasing route or a distance-shortest route is selected as the route retrieval conditions in the route providing unit 327 using the navigation device 16, the selected route retrieval conditions are recorded in the auxiliary storage device 11A or the like, the route retrieval conditions are read from the auxiliary storage device 11A when the route providing unit 327 performs the process of Step S3, and a route is automatically selected based on the read route retrieval conditions.

When the selected route is provided by displaying the route on the display device 17 or the like in Step S4, travel guidance for the route is started in Step S5.

When it is determined in Step S2 that there is no charging equipment at the destination (Step S2: NO), a route from the current location to the destination is retrieved in Step S6.

In Step S6, for example, both of a route in which a moving distance to the destination is the shortest and a route in which a moving time to the destination is the shortest may be retrieved out of a plurality of routes (including a bypass route) including a place in which charging equipment is installed, both routes may be provided to a user, and one route may be allowed to be selected by the user, or one route may be automatically selected based on the preset route retrieval conditions.

When the selected route including the place in which charging equipment is installed is provided by displaying the route on the display device 17 or the like in Step S7, travel guidance for the route is started in Step S8.

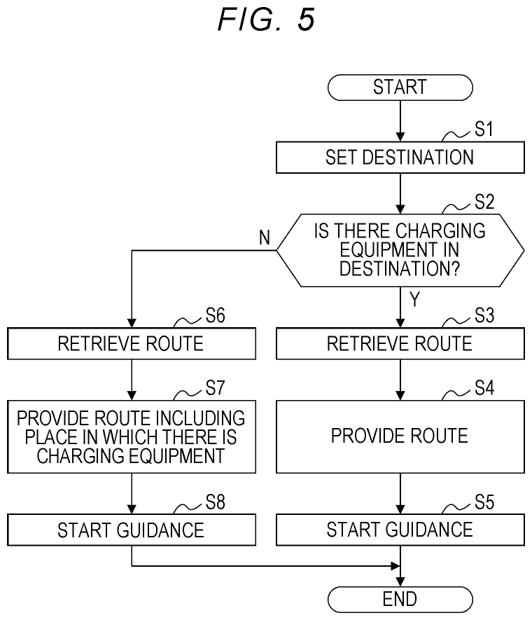

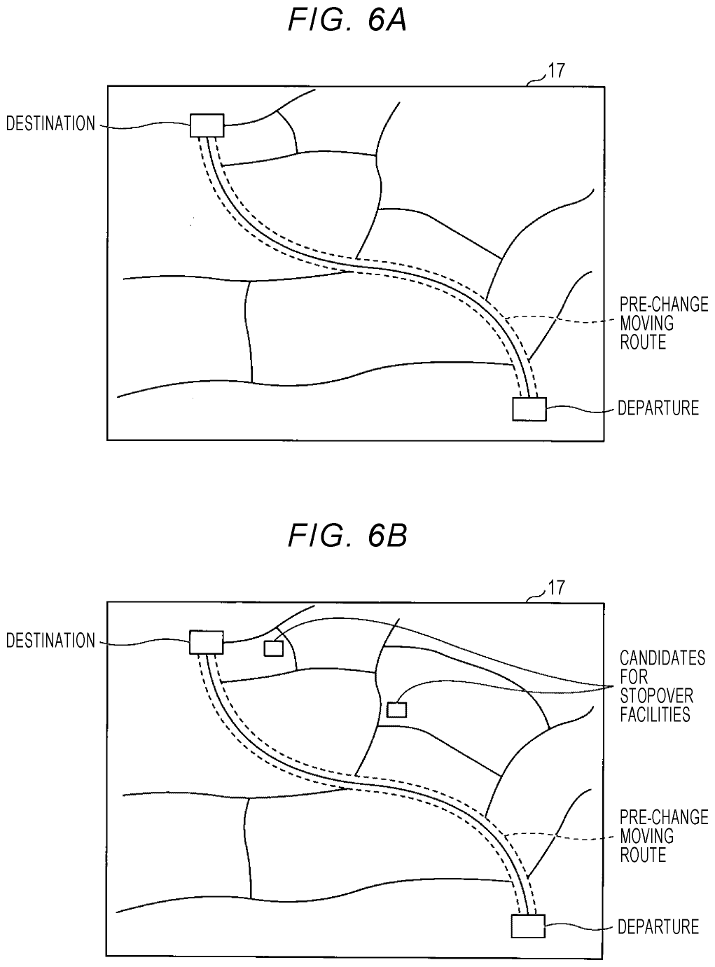

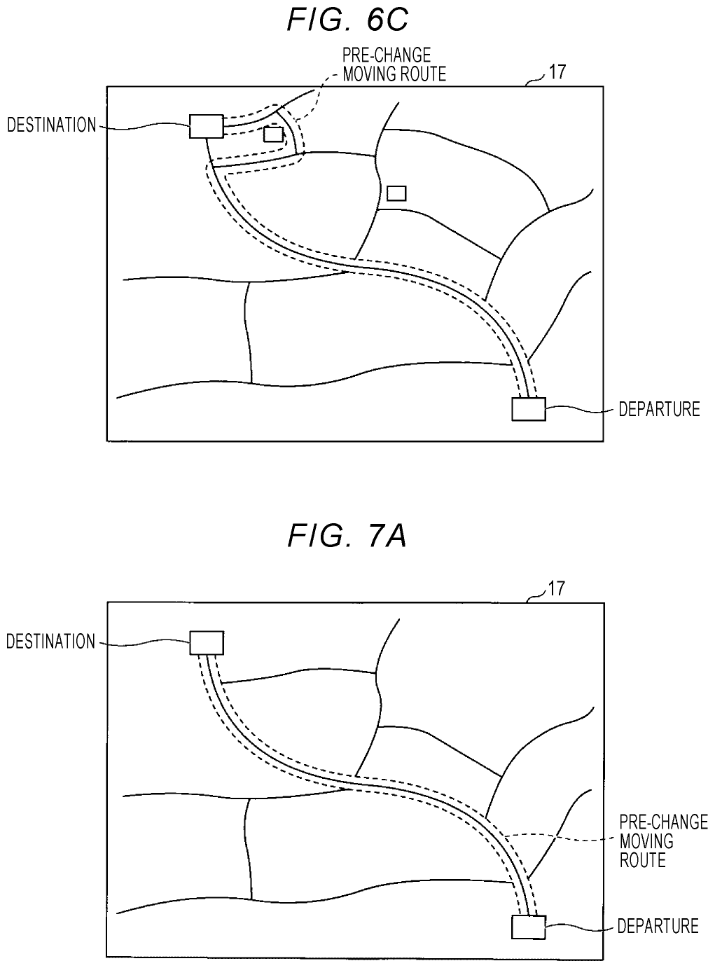

FIG. 6A is a first diagram illustrating an example of an operation of providing a place in which charging equipment closest to a destination is installed as a transit point when there is no charging equipment at a destination. FIG. 6B is a second diagram illustrating an example of an operation of providing a place in which charging equipment closest to a destination is installed as a transit point when there is no charging equipment at a destination. FIG. 6C is a third diagram illustrating an example of an operation of providing a place in which charging equipment closest to a destination is installed as a transit point when there is no charging equipment at a destination.

FIG. 6A illustrates an example in which a shortest route from a current location to a destination is displayed as a pre-change moving route on the display device 17. FIG. 6B illustrates a plurality of candidates for a stopover facility (places in which charging equipment is installed). FIG. 6C illustrates an example in which a route including a place in which charging equipment closest to the destination is installed as a transit point out of the candidates for a stopover facility is displayed as a post-change moving route on the display device 17.

By providing a route including a place in which charging equipment closest to the destination is installed, it is possible to decrease a traveling distance from the closest charging equipment and to allow the vehicle to arrive at the destination with a large residual capacity of the battery. Accordingly, for example, even when the vehicle travels on a next day of the day on which the user arrived at a hotel, the user can move to a next destination with ease without paying attention to the residual battery capacity

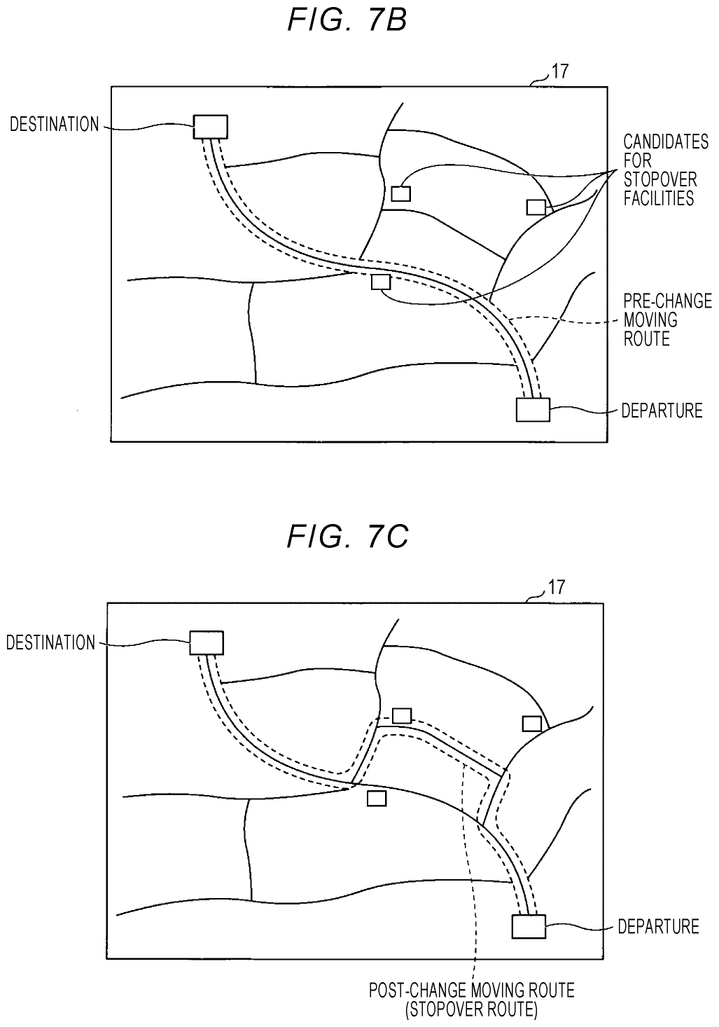

FIG. 7A is a first diagram illustrating another example of an operation of providing a place in which charging equipment closest to a destination is installed as a transit point when there is no charging equipment at a destination. FIG. 7B is a second diagram illustrating another example of an operation of providing a place in which charging equipment closest to a destination is installed as a transit point when there is no charging equipment at a destination. FIG. 7C is a third diagram illustrating another example of an operation of providing a place in which charging equipment closest to a destination is installed as a transit point when there is no charging equipment at a destination.

Similarly to FIG. 6A, FIG. 7A illustrates an example in which a shortest route from a current location to a destination is displayed as a pre-change moving route on the display device 17. For example, the shortest route is an expressway. FIG. 7B illustrates a plurality of candidates for a stopover facility (places in which charging equipment is installed). In the example illustrated in FIG. 7B, charging equipment is installed in a parking area on an expressway and charging equipment is also installed in facilities along a general road other than the expressway. The charging equipment closest to the destination out of the candidates for a stopover facility is charging equipment which is installed in the parking area. When the charging equipment installed in the parking area is being used by another user and is set as a stopover candidate, there is a possibility that charging with the charging equipment will not be performed and the vehicle will arrive at the destination earlier via another route. In this case, the route providing unit 327 narrows the plurality of candidates for a stopover facility to facility candidates which are not used by other users, selects a route including a place in which charging equipment closest to the destination is installed as a transit point out of the narrowed facility candidates, and provides the selected route to the user. A state in which the route provided in this way is displayed on the display device 17 is illustrated in FIG. 7C. In this way, by providing a shortest route except for a place in which there is charging equipment in use out of a plurality of candidates for a stopover facility (places in which charging equipment is installed), it is possible to decrease an arrival time or a moving route to the destination while using a route including a place in which available charging equipment is installed. Accordingly, a user can make a moving plan with ease.

As described above, an information providing device according to this embodiment includes a destination setting unit configured to set a destination of a motor-driven vehicle based on an input operation of a user of the motor-driven vehicle, a charging equipment retrieving unit configured to retrieve whether there is charging equipment by which the motor-driven vehicle is able to be charged at the destination, and a route providing unit configured to change a route on which the motor-driven vehicle moves to the destination depending on whether there is charging equipment at the destination and to provide the route to the user of the motor-driven vehicle.

According to this configuration, it is possible to change a manner of providing information on charging equipment at the time of movement to a destination depending on whether there is charging equipment at the destination. Accordingly, for example, when there is no charging equipment at a destination, information on charging equipment closest to the destination can be provided as a transit point in preference to other conditions such as early arrival or a short route such that a battery is substantially fully charged at the time of start of movement the next time. When there is charging equipment at a destination, information on charging equipment can be provided as a transit point with priority given to other conditions such as early arrival or a short route such that the motor-driven vehicle does not depart from a route defined based on the other conditions even when charging is required while moving to the destination. Accordingly, a user of the motor-driven vehicle can make a driving plan with ease and enjoy a drive with ease.

An information providing program according to this embodiment causes a computer to perform: setting a destination of a motor-driven vehicle based on position information indicating a current position of the motor-driven vehicle; retrieving whether there is charging equipment by which the motor-driven vehicle is able to be charged at the destination; and changing a route on which the motor-driven vehicle moves to the destination depending on whether there is charging equipment at the destination and providing the route to a user of the motor-driven vehicle. Accordingly, without greatly improving a computer such as the ECU 11, it is possible to change a manner of providing information on charging equipment at the time of movement to a destination depending on whether there is charging equipment at the destination.

The configuration described above in the embodiment represents an example of the details of the disclosure and may be combined with a different known technique or a part of the configuration may be omitted or modified without departing from the gist of the disclosure.

What is claimed is:

1. An information providing device comprising:
a destination setting unit configured to set a destination of a motor-driven vehicle based on an input operation of a user of the motor-driven vehicle;
a charging equipment retrieving unit configured to retrieve whether there is charging equipment by which the motor-driven vehicle is able to be charged at the destination; and
a route providing unit configured to change a route on which the motor-driven vehicle moves to the destination depending on whether there is charging equipment at the destination and to provide the route to the user of the motor-driven vehicle.

2. The information providing device according to claim 1, wherein the route providing unit includes a first route providing unit configured to select a route in which a moving distance of the motor-driven vehicle to the destination is the shortest out of a plurality of routes and to provide the selected route when there is charging equipment at the destination.

3. The information providing device according to claim 1, wherein the route providing unit includes a second route providing unit configured to select a route in which a moving time of the motor-driven vehicle to the destination is the shortest out of a plurality of routes and to provide the selected route when there is charging equipment at the destination.

4. The information providing device according to claim 1, wherein the route providing unit includes a third route providing unit configured to select a route including a place in which the charging equipment closest to the destination is provided out of a plurality of routes in which a moving distance of the motor-driven vehicle to the destination is longer than the moving distance of the motor-driven vehicle to the destination when there is charging equipment at the destination and to provide the selected route when there is no charging equipment at the destination.

5. The information providing device according to claim 1, wherein the route providing unit includes a fourth route providing unit configured to select a route including a place in which the charging equipment closest to the destination is provided out of a plurality of routes in which an arrival time of the motor-driven vehicle at the destination is later than the arrival time of the motor-driven vehicle at the destination when there is charging equipment at the destination and to provide the selected route when there is no charging equipment at the destination.

6. An information providing program causing a computer to perform:
setting a destination of a motor-driven vehicle based on position information indicating a current position of the motor-driven vehicle;
retrieving whether there is charging equipment by which the motor-driven vehicle is able to be charged at the destination; and
changing a route on which the motor-driven vehicle moves to the destination depending on whether there is charging equipment at the destination and providing the route to a user of the motor-driven vehicle.
